(19) United States
(12) Patent Application Publication
(10) Pub. No.: US 2008/0205207 A1
(43) Pub. Date: Aug. 28, 2008

(54) Radial Tracking Method and Apparatus for an Optical Information Carrier Format with Non-Uniformly Spaced Tracks

(75) Inventors: Jacobus Maarten Den Hollander, Eindhoven (NL); Bin Yin, Eindhoven (NL); Juil Lee, Pittsburgh, PA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,437

(22) PCT Filed: May 16, 2006
(86) PCT No.: PCT/IB2006/051543

§ 371 Date: Nov. 26, 2007

(30) Foreign Application Priority Data
May 31, 2005 (EP) 05104662.1

(51) Int. Cl. G11B 7/007; G11B 7/09

(52) U.S. Cl. 369/44.13

(57) ABSTRACT

A radial tracking method for an optical information carrier format with non-uniformly spaced tracks is disclosed, wherein a plurality of tracks (21, 22, 23) are spaced apart at a track pitch TP2, respectively, within a broad spiral (20) having a track pitch TP, in an information layer of an optical information carrier. One central high intensity spot (25) and a plurality of symmetrically placed satellite spots (26, 27) are used for generating a tracking signal for said broad spiral (20). According to an embodiment, the push-pull signal is used for this purpose, resulting in a robust tracking signal. Further, unique address information is retrieved from each of the individual tracks within this broad spiral from a wobble of said tracks. As a result, higher storage densities are achieved, as the method enables tracking of narrowly spaced sub-tracks in a broad spiral that was previously not possible.

This invention pertains in general to the field of optical storage media and corresponding read and/or write apparatuses. More particularly the invention relates to a radial tracking method for an optical storage medium or optical information carrier, such as an optical disc, having a format with non-uniformly spaced tracks, as well as a corresponding apparatus for performing such a method.

In optical recording various generations of optical information carriers, usually in the form of optical discs, are succeeding each other, depending on physical parameters like wavelength and NA of objective lens.

In the 12 cm world, CD was first, then DVD, now Blu-ray Disc (BD) and/or HD-DVD and/or other versions like the Chinese proposal EVD.

All these types of optical storage media have in common that an optical storage medium, usually in the form of an optical disc is rotated, driven by a spindle motor, for accessing such a disc by means of an optical system scanning an information layer during rotation of the disc.

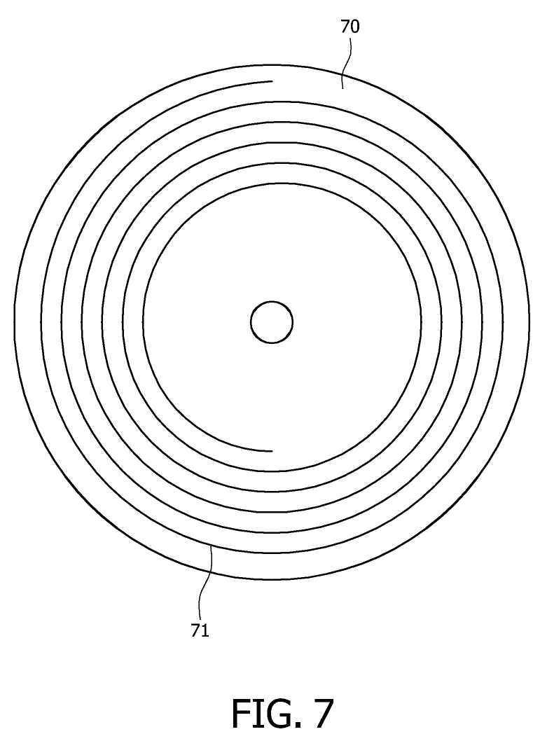

In conventional optical drives for reading from or writing to these optical storage media, such as a DVD player, information is read from or written to an optical storage medium, such as a disc 70, of the type that stores optically readable information in the form of a spiral track 71, as illustrated in FIG. 7.

The track density and optical parameters of the read out system, like wavelength of the readout radiation, determine the maximum amount of information that may be stored on such optical storage media.

One way to increase the storage density of such optical storage media is to reduce the distance between the tracks, in which the data is written, which is called the track pitch (TP). However, reducing the track pitch is limited by e.g. increased radial cross talk, because information is increasingly read from several adjacent tracks at a time, and it makes robust radial tracking more difficult because it gets more and more difficult to differ adjacent tracks from each other. More precisely, reducing the track pitch increases the inter-track interference, which also is called cross-talk, during read-out. Moreover, it increases cross-erase, also called cross-write, during writing of the track on the optical storage medium. The effects of cross-talk can up to a certain limit be reduced by means of cross-talk cancellation, e.g. by using a three-spot read-out arrangement, which for instance is disclosed in U.S. Pat. No. 5,615,185. The effects of cross-erase on the other hand, may up to a certain limit be reduced by providing a good thermal separation between the tracks, wherein a groove-only format is in this respect preferred to a land-groove format.

However, once the track pitch reaches a certain limit, the tracks cannot be separated any more by the read-out system. For instance, when the track pitch (TP), in a system with NA=0.85 and λ=405 nm, is smaller than 238 nm, the conventional push-pull tracking signal disappears. Moreover, the differential-time-detection (DTD) based radial tracking will not work either since the DTD signal looks at the combination of radial and tangential diffraction.

Different formats of optical storage media have been proposed facilitating robust radial tracking schemes, whereof one is to have several small track pitches within a broad spiral, wherein the broad spirals are separated by an empty guard band. However, a disadvantage with this system is that, due to a need for a grating that can be rotated, complexity, cost and power dissipation of the optical pick-up unit (OPU) are increased. Further, as such a system uses the guard band for radial tracking, this has several disadvantages.

In legacy writing systems, the push-pull channel is used to pass address information to the drive. The address information is embedded in the tracks by means of a wobble. In case of a tracking scheme that tracks on a guard band, this would require a wobbled guard-band. This is undesired for several reasons. For instance, if the address information is contained in the guard band, there is no unique address information for each of the individual tracks inside the broad spiral. This does not only deviate from the implementation of the address information in legacy systems but moreover, it requires different tangential densities for the individual tracks if the number of tracks within the broad spiral reaches a certain value at which the phase misalignment between inter-track bits cannot be neglected given the uniform tangential density. This complicates the design of such a system and even reduces the storage capacity of the storage medium.

According to another method unique addressing of the tracks within the broad spiral is provided by encoding the address information in the land, wherein the groove, i.e. the track, separating the lands, has a varying width. However, this makes mastering of the optical storage medium, usually in the form of an optical disc, more difficult and an asymmetric constellation of the spots on the storage medium is required. Such a constellation is more complicated and less efficient in terms of optical power, than a symmetrical constellation.

Thus, there is a need for a new optical recording/reproducing apparatus for an optical storage medium for an optical recording medium having improved storage capacity thanks to several small track pitches within a broad spiral thereon.

Hence, such an improved system would be advantageous, and in particular such a system allowing for increased flexibility, cost-effectiveness, and/or power efficiency would be advantageous, wherein a specific desired advantage is an increased optical storage density of an optical storage medium.

Accordingly, the present invention preferably seeks to mitigate, alleviate or eliminate one or more of the above-identified deficiencies in the art and disadvantages singly or in any combination and solves at least the above mentioned problems at least partly by providing an optical recording/reproducing apparatus for an optical storage medium, such as an optical disc, having improved storage capacity, a corresponding radial tracking method advantageous for recording/reproducing information to/from such optical storage media, and a corresponding computer program according to the appended patent claims.

The solution according to the invention is to provide previously unknown radial tracking allowing for increased optical storage density by enlarging track density in radial direction of the optical information carrier.

According to a first aspect of the invention, a radial tracking method for an optical information carrier format with non-uniformly spaced tracks, in a reading/writing apparatus configured for reading from and/or writing to an optical information carrier, preferably an optical disc, having an information layer of said optical information carrier format, is provided, wherein, in said information layer, a plurality of tracks are spaced apart at a track pitch TP2, respectively, within a broad spiral having a track pitch TP, and wherein each of said tracks comprises addressing information. The method comprises generating a tracking signal for a central track of said plurality of tracks in the broad spiral by using a plurality of spots comprising one central high intensity spot and satellite spots thereof, wherein the number of satellite spots is at least equal to the number of tracks in the broad spiral minus one, and generating a read-out signal from said optical information carrier by using the central high intensity spot.

According to another aspect of the invention, a reading/writing apparatus for performing a radial tracking method for an optical information carrier format with non-uniformly spaced tracks, for performing the method according to a first aspect of the invention, is provided. The apparatus is configured for reading from and/or writing to an optical information carrier, preferably an optical disc, having an information layer of said optical information carrier format, wherein, in said information layer, a plurality of tracks are spaced apart at a track pitch TP2, respectively, within a broad spiral having a track pitch TP, and wherein each of said tracks comprises addressing information. The apparatus comprises means for generating a tracking signal for a central track of said plurality of tracks in said broad spiral, in use having a plurality of spots comprising one central high intensity spot and satellite spots thereof, wherein the number of satellite spots is at least equal to the number of tracks in the broad spiral minus one, and means for generating a read-out signal from said optical information carrier by using the central high intensity spot, wherein the aforementioned means are operatively connected to each other.

According to a further aspect of the invention a computer-readable medium having embodied thereon a computer program performing a radial tracking method according to the above first aspect of the invention, for an optical information carrier format with non-uniformly spaced tracks, for processing by a computer, is provided. The computer program is configured for reading from and/or writing to an optical information carrier, preferably an optical disc, having an information layer of said optical information carrier format having non-uniformly spaced tracks, wherein, in said information layer, a plurality of tracks are spaced apart at a track pitch TP2, respectively, within a broad spiral having a track pitch TP, and wherein each of said tracks comprises addressing information. The computer program comprises a first code segment for generating a tracking signal for a central track of said plurality of tracks in said broad spiral using a plurality of spots comprising one central high intensity spot and satellite spots thereof, wherein the number of satellite spots is at least equal to the number of tracks in the broad spiral minus one, and a second code segment for generating a read-out signal from said optical information carrier by using the central high intensity spot.

The present invention has a number of advantages over the prior art because it provides for instance a unique wobble-based addressing of each track in case of recordable systems; and a simpler implementation because of a symmetric read-out spot constellation. Such an improved system is advantageous, in particular as such a system allows for increased flexibility as the invention may be used with a variety of non-uniformly spaced track geometries; increased cost-effectiveness as higher storage densities in practice can be used because an implementation for a read-out system is provided; and/or increased power efficiency as larger amounts of data may be read from a similar storage area than previously known; and an increased optical storage density of an optical information carrier with non-uniformly spaced tracks.

These and other aspects, features and advantages of which the invention is capable of will be apparent and elucidated from the following description of embodiments of the present invention, reference being made to the accompanying drawings, in which

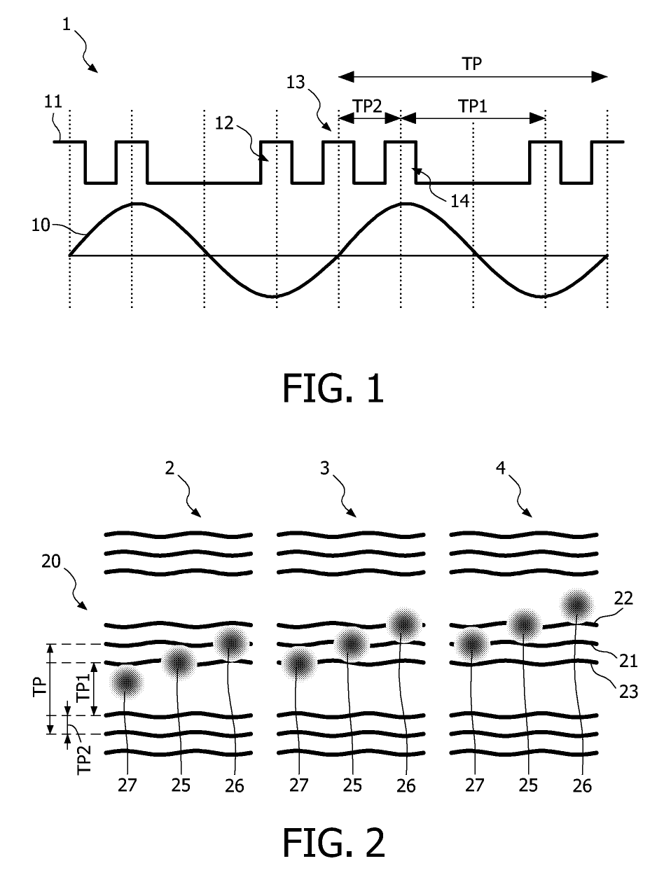

FIG. 1 is a schematic illustration of an example of the push-pull signal in case of a broad spiral of three tracks, used in an exemplary embodiment of the invention;

FIG. 2 is a schematic illustration of an embodiment of the radial tracking method according to the invention for a broad spiral of three tracks, wherein the spot generating the push-pull signal used for tracking is indicated individually by 26, 25, and 27 in case of 2,3, and 4, respectively, and in all cases, the central spot reads out the wobble as well as the read-out signal;

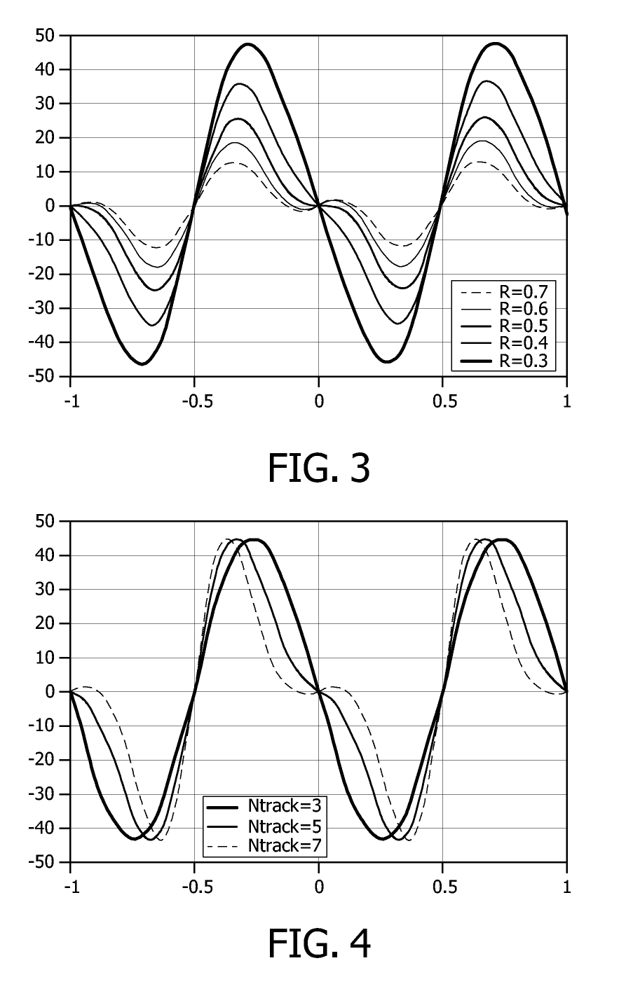

FIG. 3 is a schematic illustration of an example of the push-pull signal with various exemplary ratios R between track pitches TP1 and TP2, wherein a Braat-Hopkins model is used with BD parameters, and TP is fixed to be 640 nm;

FIG. 4 is a schematic illustration of an example of the push-pull signal with various number of tracks in one broad spiral, wherein a Braat-Hopkins model is used with BD parameters, TP 1 is chosen to be 320 nm, and R is set to exemplary 0.3;

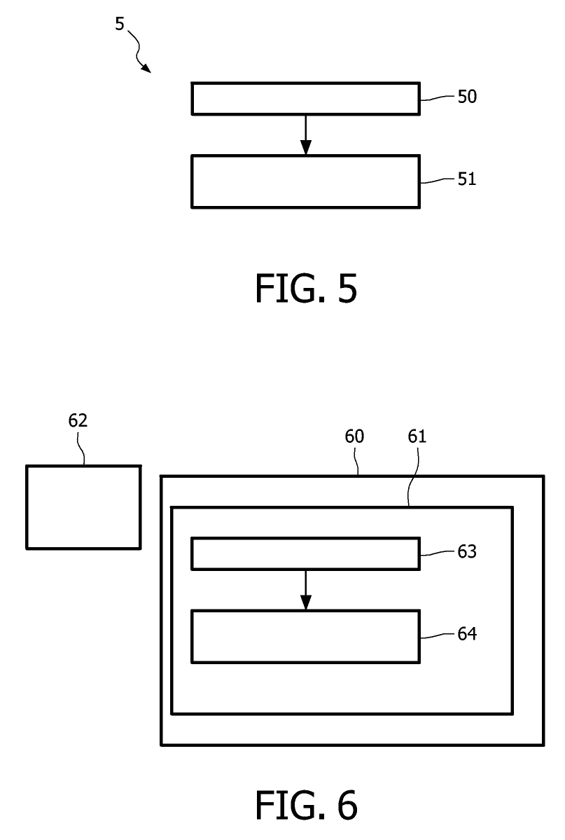

FIG. 5 is a flowchart illustrating the radial tracking method according to the embodiment of the invention;

FIG. 6 is a schematic illustration of a computer readable medium comprising program code segments according to another embodiment of the invention:

FIG. 7 is a schematic illustration of a conventional optical disc with a spiral track;

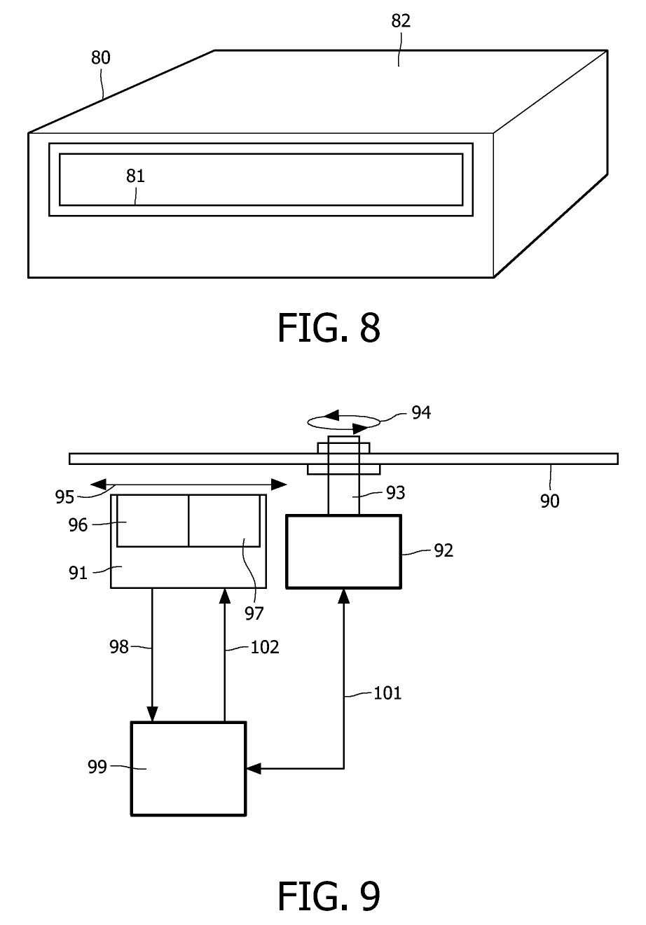

FIG. 8 is a schematic illustration of an exemplary embodiment of the apparatus according to the invention, showing an optical disc reader for accessing an optical disc; and

FIG. 9 is a schematic illustration of functional components in the optical disc reader according to FIG. 8.

The following description focuses on an embodiment of the present invention applicable to a Blu-ray Disc (BD) and in particular to an exemplary embodiment having three sub-tracks in a broad spiral in an information layer of that BD. However, it will be appreciated that the invention is not limited to this exemplary application but may be applied to many other optical storage media having a different number of sub-tracks or satellite spots, or having a different shape than that of a circular disc.

According to the present embodiment, a tracking scheme 5 for an optical disc 90 in the form of a BD, with non-uniformly spaced tracks 21, 22, 23 in a broad spiral 20 is provided. The optical disc 90 may both be applied with read-only and writing systems 80. An exemplary embodiment of such a system 80 is given below.

In an exemplary, and by no means limiting, embodiment of the invention for performing the method according to the invention, according to FIGS. 8 and 9, an optical disc reading device 80 for accessing an optical disc 90 having a format with non-uniformly spaced tracks, as for instance illustrated in FIGS. 1 and 2, is provided. The device 80 is a read and/or write apparatus for such an optical disc 90, and according to the present embodiment, the device 80 is a BD read and/or write apparatus, comprising a tray 81 or other suitable arrangement for feeding the disc 90 (BD), hereinafter denoted as “disc” or “optical disc”, into a housing 82 of the optical disc reading and/or writing apparatus 80. The apparatus is for instance a drive of a computer or a consumer player for optical discs, and is hereinafter denoted as “drive” 80. The optical disc 90 to be accessed by means of the drive 80 comprises at least one information storing layer to be accessed by device 80, wherein the information layer comprises the above mentioned non-uniformly spaced tracks. The drive 80 comprises a means 91 for accessing such a disc 90, e.g. a laser pickup.

More precisely, a disc drive assembly 92, 93 in the form of a spindle motor 92 and a rotatable spindle 93 is adapted to rotate the optical disc 90 in a direction indicated by arrow 94 in FIG. 9, in a manner which is well known in the art. A laser pickup unit 91 is positioned close to the surface opposite a label side of the optical disc 90 and is movable in a radial direction of the optical disc 90, as is indicated by the arrow 95 in FIG. 9. The laser pickup unit 91 operates to irradiate the optical disc 90 with laser light from a light irradiation unit 96. In this embodiment, this is implemented by the three spots 25, 26, 27 of FIG. 2, described in more detail below. Reflections from the optical disc are detected by means of a detector 97, which produces a readout signal in response thereof and provides this signal for further processing, for instance to produce the push-pull signal illustrated in FIG. 1. When accessing information from the disc 90, the optical disc 80 will be kept in rotation by the disc drive unit, i.e. the spindle motor 92 and the spindle 93.

The laser pickup unit 91 comprises mechanical drive means (not illustrated) for causing the optical assembly or optical read device 96, 97 of the laser pickup unit 91 to move radially along the surface of the optical disc 90 in the direction of arrow 95 indicated in FIG. 9 between different radial positions. However, such mechanical drive means are well known per se in the technical field, and it is left to the skilled person to choose the suitable mechanical and electrical components, such as an electric motor and a mechanical carriage arrangement, depending on an actual implementation. In essence, any equipment will do, which is capable of making the optical components 96, 97 of the laser pickup unit 91 move with high precision in the desired radial direction. Furthermore, the laser source may be chosen among a variety of commercially available components and may operate in a desired wavelength range, for instance at about 800 nm (infrared) for a CD, 650 nm (red) for a DVD, or 405 nm (blue), as in the present embodiment, for a BD.

The output signal from the laser pickup unit 91 is an information signal 98 that arises from the scattering, absorption and reflection from the information layer of the disc 90. A processing device, such as a processor, 99 of the drive 80 may be implemented by any commercially available microprocessor. Alternatively, another suitable type of electronic logic circuitry, for instance an Application-Specific Integrated Circuit (ASIC) or a Field-Programmable Gate Array (FPGA) may substitute the processor 99. Correspondingly, further components, such as memory, input devices and output device of the drive (not illustrated) may all be implemented by commercially available components and are not described in any detail herein.

The processor 99 controls the function of drive 80. For instance, the processor controls the rotational speed of spindle motor 92, as indicated by line 101; the radial position of the pickup unit 91, as indicated by signal line 102; and receives the information signal 98 for further processing, e.g. for various tracking servos and error correction, or for decoding and sending to an audio-visual unit for presentation of audio-visual data read from disc 90.

An example 1 for the broad spiral on disc 90 is shown in FIG. 1, showing an example of the push-pull signal 10 in case of a broad spiral of three tracks 12, 13, 14, shown in groove structure 11. The broad spiral with a track pitch TP consists of three tracks 12, 13, 14 spaced at track pitch TP2. For a (re)writable format disc, each of the tracks 12, 13, 14 in the broad spiral contains its own unique address information in the wobble of the track. The broad spiral gives rise to a push-pull signal 10, as shown in FIG. 1. The amplitude of this signal is relatively large since the spatial frequency of the broad spiral is well within the cut-off frequency of the channel. The spatial frequency of the tracks 12, 13, 14 within the broad spiral however is beyond this cut-off frequency.

For read-out, one high intensity spot 25 and symmetrically placed satellite spots 26, 27 are used, wherein the number of satellite spots generally is at least equal to the number of tracks in the broad spiral minus one. The distance in the radial direction between the satellite spots and the main spot must be equal to N times TP2 plus M times TP, where N is the number of the satellite spots counted from the central spot and M is an integer, equal to or bigger than zero. The distance in the tangential direction between a satellite spot and the main spot has to be larger than the spot diameter. An example of a tracking scheme for a broad spiral of three tracks is given in FIG. 2, here M equals zero, which results in one high intensity spot 25 and symmetrically placed satellite spots 26, 27. The radial distance between the spots in the case of FIG. 2. is TP2.

In FIG. 2 the three cases 2, 3, 4 of reading out single tracks 21, 22, 23 of the broad spiral 20 are shown. More precisely, the following is illustrated: reading out 2 the lower track 23, reading out 3 the middle track 21, and reading out 4 the upper track 22. The spot generating the push-pull signal used for tracking is indicated individually by 26, 25, and 27 in case of 2, 3, and 4, respectively, and in all cases, the central spot reads out the wobble as well as the read-out signal. More precisely, the tracking scheme according to the present embodiment of the invention uses the push-pull signal, which is a result of the track pitch TP of the broad spiral 20. Selection of the track 21, 22, 23 within the broad spiral 20 is done by choosing the push-pull signal from the appropriate spot on the disc as shown in FIG. 2. This spot is kept in the center of the broad spiral by the existing radial servo system of the disc reading/writing apparatus. Hence, a tracking signal 10 for a central track 21 of said plurality of tracks 21, 22, 23 in said broad spiral 20, is generated in step 50 of method 5, as shown in FIG. 5. The wobble information, which is contained in each track 21, 22, 23 as illustrated in FIG. 2, is read out by the high intensity central spot 25, which is the spot that is used for reading and writing the data from/to the optical disc. The main spot 25 has a significantly higher power than the satellite spots 26, 27 have, wherein the intensity of the satellite spots 26, 27 is about 10% of that of the main spot. As is shown in FIG. 1, when the spot is located on any of the tracks 12, 13, 14, corresponding to tracks 22, 21, 23 of FIG. 2, in the broad spiral other than the central track, the push-pull signal is unequal to zero. This means the wobble will be modulated on a DC value. This DC component may be removed by means of a high-pass filter or a band-pass filter for adequate further processing in the disc reading/writing apparatus 80.

To maintain a robust push-pull signal, the spatial frequency of broad spirals 20, which is determined by the TP, must be well within the optical cutoff. Based on that, the ratio R between TP1 and TP2 is adjusted in such a way that, for a push-pull signal, meaningless zeros are removed and its modulation satisfies existing specifications, wherein TP1 is the track pitch between adjacent outer and inner tracks, respectively, of the broad spiral, as illustrated in FIG. 1, which gives a measure for the distance between the “broad tracks” of the broad spiral comprising several single tracks itself. The skilled person will be aware of how an optimal ratio is chosen from this framework. A simulation example is given in FIG. 3, where a Braat-Hopkins model is used with NA=0.85 and λ=405 nm. TP is chosen to be 640 nm and R=TP2/TP1 is defined as the ratio. In FIG. 3 and FIG. 4 the horizontal axis shows the Offtrack in fractions of TP, and the vertical axis shows the push-pull signal amplitude. In FIG. 3 it can be seen that reducing R eliminates nonsense zero crossings and gives a larger modulation to the push-pull signal. The reduction of R is limited by the cross-talk and cross-erase effects.

Hence, the exemplary method 5 comprises in step 51, as shown in FIG. 5, that one central high intensity spot 25 and a plurality of symmetrically placed satellite spots 26, 27 are used for generating a read-out signal from an optical disc 90 for generating a tracking signal 10, wherein the number of satellite spots is at least equal to the number of tracks in the broad spiral minus one.

Moreover, a disc reading/writing apparatus 80 for performing the radial tracking method 5 for an optical disc format with non-uniformly spaced tracks 21, 22, 23 is described above. The apparatus is configured for reading from and/or writing to an optical disc 90 having an optical disc format with non-uniformly spaced tracks, wherein a plurality of tracks are spaced apart at a track pitch TP2, respectively, within a broad spiral 20 having a track pitch TP, in an information layer on an optical disc 90, and wherein each of said tracks 21, 22, 23 comprises addressing information. The apparatus comprises further means (specifically microprocessor 99) for generating a tracking signal 10 for a central track 21 of the plurality of tracks 21, 22, 23 in the broad spiral 20. The means for generating a tracking signal 10 produce in use a plurality of spots 25, 26, 27 comprising one central high intensity spot 25 and satellite spots 26, 27 thereof, wherein the number of satellite spots 26, 27 is at least equal to the number of tracks in the broad spiral minus one. Furthermore, the apparatus comprises means (e.g. suitable electronics or a computer program) for generating a read-out signal from said optical disc 90 by using (step 51) the central high intensity spot 25, wherein the aforementioned means are operatively connected to each other so that the apparatus 80 implements the present embodiment of the invention.

As mentioned above, the tracking method according to the present invention does not exclude the case where the number of tracks within a broad spiral, Ntrack, is more than 3. In FIG. 4, the simulation results for Ntrack=5 and Ntrack=7 are shown. In the simulations TP1=320 nm is chosen and R is fixed to be 0.3. With the increase of tracks, the modulation of the push-pull signal remains unchanged, but the signal quality around zero crossings degrades, showing as the decrease of the slope and the appearance of nonsense zeros. This effect poses the upper limit on Ntrack.

According to further embodiments, which are not further illustrated herein, the tracking-error signal is generated in differential phase detection (DPD), or alternatively in differential-time-detection (DTD). Compared to the above described “push-pull method”, the DPD or DTD tracking signal method has the advantage that it is less influenced by a channel disturbance, especially by radial tilt. On the other hand, the push-pull signal is less influenced by crosstalk from neighboring tracking. In case a Quadrant photo detector, known in the art and having four quadrants A, B, C, D, is used in the optical unit 91 as a detector 97, the (radial) Push Pull signal is defined as (A+B)-(C+D), whereas the DPD signal is defined as the diagonal phase difference and is, depending on the configuration of the detector, normally defined as phase(A+C)-phase(B+D), or in some cases as phase(A+D)-phase(B+C). Of course, this embodiment also uses the plurality of spots, as described in detail above in order to generate the alternative tracking signals.

An asymmetric arrangement of the tracks would also be possible. In this case, the distribution of the read-out spots would be correspondingly asymmetrical. However, as this arrangement has a lower data density, it is not further elucidated herein.

A further embodiment of the invention is illustrated in FIG. 6 showing a computer-readable medium 60 having embodied thereon a computer program 61 performing a radial tracking method according to another embodiment of the invention, as described above, wherein the computer program comprises corresponding code segments described below. The computer program 61 is provided for an optical disc format with non-uniformly spaced tracks 21, 22, 23 (FIG. 2), for processing by a computer 62, for instance the microprocessor 99 of drive 80 (FIGS. 8 and 9). The computer program is configured for a disc reading/writing apparatus 80 (FIG. 8) for reading from and/or writing to an optical disc 90 (FIG. 9), which has an optical disc format with non-uniformly spaced tracks, wherein a plurality of tracks are spaced apart at a track pitch TP2, respectively, within a broad spiral 20, which has a track pitch TP, in an information layer on the optical disc 90, and wherein each of the tracks 21, 22, 23 comprises addressing information, as already described above. The computer program comprises a first code segment 63 for generating a tracking signal 10 for a central track 21 of said plurality of tracks 21, 22, 23 in said broad spiral 20 using a plurality of spots 25, 26, 27 comprising one central high intensity spot 25 and satellite spots 26, 27 thereof, wherein the number of satellite spots 26, 27 is at least equal to the number of tracks in the broad spiral minus one, and a second code segment 64 for generating a read-out signal from said optical disc 90 by using the central high intensity spot 25.

In summary, the present invention solves the problems associated with the prior art, and provides higher storage density of optical storage discs, as it enables tracking of narrowly spaced sub-tracks in a broad spiral that was previously not possible. In this specification, a new radial tracking method for a disc format with non-uniformly spaced tracks is disclosed. According to one embodiment, a push-pull signal is used which has the period of the broad spiral, resulting in a robust tracking signal. Further, unique address information may be retrieved from each of the individual tracks within this broad spiral. As a result, higher storage densities are achieved.

Applications and use of the above described method and apparatus according to the invention are various and include exemplary fields such as computer drives for optical discs, consumer players and recorders for optical discs, etc.

The invention may be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different number of sub-tracks than those described above. Furthermore, the invention is not limited to disc-shaped optical storage media. Moreover, any optical information carrier having the described non-uniform track arrangement in an information layer, including e.g. credit card shaped optical storage media, may be used for implementing the invention.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A radial tracking method (5) for an optical information carrier format with non-uniformly spaced tracks (21, 22, 23), in a reading/writing apparatus (80) configured for reading from and/or writing to an optical information carrier (90) having an information layer of said optical information carrier format,
wherein, in said information layer, a plurality of tracks are spaced apart at a track pitch TP2, respectively, within a broad spiral (20) having a track pitch TP, and
wherein each of said tracks comprises addressing information, said method comprising:
generating (50) a tracking signal (10) for a central track (21) of said plurality of tracks (21, 22, 23) in said broad spiral (20) by using one of a plurality of spots (25, 26, 27) comprising one central high intensity spot (25) and satellite spots (26, 27) thereof, wherein the number of satellite spots (26, 27) is at least equal to the number of tracks in the broad spiral minus one, and
generating a read-out signal from said optical information carrier (90) by using (51) the central high intensity spot (25).

2. The method according to claim 1, wherein the distance in the radial direction between the satellite spots (26, 27) and the central high intensity spot (25) is equal to N times TP2 plus M times TP, wherein N is the number of the satellite spot (26, 27) counted from the central high intensity spot (25) and M is an integer, equal to or bigger than zero, and wherein the distance in the tangential direction between a satellite spot and the central high intensity spot is larger than the spot diameter.

3. The method according to claim 1, wherein said tracking signal is a push-pull signal (10) resulting from the track pitch TP of the broad spiral (20).

4. The method according to claim 3, comprising
selecting a track (21, 22, 23) within the broad spiral (20) by choosing the push-pull signal from one of said spots (25, 26, 27) reading a center track (21) of said broad spiral (20), and
keeping this spot in the center of the broad spiral (20) by a radial servo system of the reading/writing apparatus (80).

5. The method according to claim 4, wherein said addressing information is wobble information that is comprised in each of said tracks (21, 22, 23), and said method comprising
reading out said addressing information by said high intensity central spot (25), which is the spot that is used for reading and/or writing the data from/to the optical information carrier (90).

6. The method according to claim 5, wherein said high intensity central spot (25) has significantly higher power than said satellite spots (26, 27), preferably the intensity of the satellite spots is about 10% of that of the central spot (25).

7. The method according to claim 3, wherein, when said high intensity central spot (25) is located on any of said tracks (22, 23) in the broad spiral (20) other than the central track (21), said method comprising
removing a DC offset value from said push-pull signal (10), preferably by filtering with a high-pass filter or a band-pass filter, for further processing in the reading/writing apparatus (80).

8. The method according to claim 1, comprising
optimizing a ratio R between TP1 and TP2 such that the spatial frequency of the broad spiral (20), which is determined by the TP, is within the optical cutoff,
wherein TP1 is the track pitch between adjacent outer and inner tracks, respectively, of the broad spiral.

9. The method according to claim 1, wherein said tracking signal is a differential phase detection (DPD) signal or a differential-time-detection (DTD) signal.

10. The method according to claim 1, wherein a number N of said plurality of tracks (21, 22, 23) is uneven so that a central track (21) has an even number of radially symmetrically positioned surrounding tracks (22, 23) on each side respectively, comprising
using said one central high intensity spot (25) for reading from and/or writing to one track (22, 23) of said plurality of tracks (21, 22, 23) within said broad spiral (20) being different than said central track (21),
reading out said addressing information of that one track (22, 23) by said high intensity central spot (25), wherein said tracking signal (10) for said central track (21) of said plurality of tracks (21, 22, 23) in said broad spiral (20) is generated by the read-out signal of the satellite spot (26, 27) of said plurality of satellite spots (26, 27) which is positioned on that central track (21), so that the broad spiral is reliably tracked, wherein said satellite spots (26, 27) are symmetrically positioned adjacent said central spot (25).

11. A reading/writing apparatus (80) for performing a radial tracking method for an optical information carrier format with non-uniformly spaced tracks (21, 22, 23) according to claim 1, said apparatus being configured for reading from and/or writing to an optical information carrier (90) having an information layer of said optical information carrier format,
wherein, in said information layer, a plurality of tracks are spaced apart at a track pitch TP2, respectively, within a broad spiral (20) having a track pitch TP, and wherein each of said tracks (21, 22, 23) comprises addressing information, said apparatus comprising
means for generating a tracking signal (10) for a central track (21) of said plurality of tracks (21, 22, 23) in said broad spiral (20), in use having a plurality of spots (25, 26, 27) comprising one central high intensity spot (25) and satellite spots (26, 27) thereof, wherein the number of satellite spots (26, 27) is at least equal to the number of tracks in the broad spiral minus one, and
means for generating a read-out signal from said optical information carrier (90) by using (51) the central high intensity spot (25)
said means being operatively connected to each other.

12. A computer-readable medium (60) having embodied thereon a computer program (61) performing a radial tracking method according to claim 1 for an optical information carrier format with non-uniformly spaced tracks (21, 22, 23), for processing by a computer (62, 99), the computer program being configured for reading from and/or writing to an optical information carrier (90) having an information layer of said optical information carrier format having non-uniformly spaced tracks, wherein, in said information layer, a plurality of tracks are spaced apart at a track pitch TP2, respectively, within a broad spiral (20) having a track pitch TP, and wherein each of said tracks (21, 22, 23) comprises addressing information, the computer program comprising
a first code segment (63) for generating a tracking signal (10) for a central track (21) of said plurality of tracks (21, 22, 23) in said broad spiral (20) using a plurality of spots (25, 26, 27) comprising one central high intensity spot (25) and satellite spots (26, 27) thereof, wherein the number of satellite spots (26, 27) is at least equal to the number of tracks in the broad spiral minus one, and
a second code segment (64) for generating a read-out signal from said optical information carrier (90) by using the central high intensity spot (25).
